(19) United States
(12) Patent Application Publication
(10) Pub. No.: US 2007/0237928 A1
(43) Pub. Date: Oct. 11, 2007

(54) Roll down poster coloring toy

(75) Inventor: Lisa Santangelo-Margulis, Levittown, NY (US)

Correspondence Address: LEVINE & MANDELBAUM, 444 MADISON AVENUE, 35TH FLOOR, NEW YORK, NY, 10022, US

(73) Assignee: Tara Toy Corporation, Hauppauge, NY (US)

(21) Appl. No.: 11/401,051

(22) Filed: Apr. 10, 2006

(51) Int. Cl. B44C 1/17

(52) U.S. Cl. 428/195.1

(57) ABSTRACT

A coloring toy including an elongated flexible web formed into a roll, the web including a series of sheets each bearing an image to be colored. The roll is mounted adjacent to a vertical support surface, such as the side of a door, so that the roll is rotatable about its horizontally-oriented longitudinal axis. The free end of the rolled web can be grasped and pulled downwardly to unroll the endmost sheet of the web and bring it to a selected vertical location. The web may be rolled on a spool and supported on a door by hooks adapted to fit over the top of the door. The adjacent sheets of the web are demarcated from one another by lines of severance. A removable weight secured to the free end of the web helps to maintain the lower-most sheet in a flat condition. A container accommodating coloring implements can be hung from a door knob.

This invention relates to coloring toys of the type in which a sheet is printed with a line drawing, and coloring implements, such as crayons, are provided for coloring in various areas defined by the line drawing.

Among toys of this type are coloring books, which have existed for many years. Also known are such toys in which a series of sheets bearing images to be colored are arranged end-to-end in the form of a roll. The roll is associated with a desk or a box, and the sheets can be pulled from the roll in sequence over the surface of the desk or box so that such surface supports the sheet as the image printed on it is colored. After coloring has been completed, the sheet can be separated from the remainder of the roll, and the following sheet pulled from the roll over the surface of the desk or box. Such arrangements are shown in U.S. published Patent Application No. 2004/0229193, as well as U.S. Pat. Nos. 6,098,793; 4,600,393; and 2,283,997.

A problem presented by coloring toys including rolls of sheets to be colored is that the size of any individual sheet to be colored is limited by the size of the desk or box surface which is to serve as a support for the sheet while it is colored. Moreover, the requirement that a desk or box be provided along with the roll of sheets to be colored adds significantly to the expense of the toy.

It is an object of the present invention to provide a coloring toy involving a rolled elongated web, preferably of paper, the web including a series of “poster size” sheets each bearing an image to be colored.

It is another object of the invention to provide such a coloring toy in which the roll can be mounted adjacent to a vertical support surface, such as the side of a door which presents a flat surface, which serves as the support surface for the sheet while the image which it bears is being colored.

It is a further object of the invention to provide such a coloring toy in which the size of each image-bearing sheet is limited only by the size of a typical door on which the roll will be supported.

It is an additional object of the invention to provide a container for holding coloring instruments, such as crayons, which can be hung from a door knob projecting from the door on which the rolled web is supported.

Additional features and objects of the invention will be apparent from the following description, in which reference is made to the accompanying drawings.

### IN THE DRAWINGS

FIG. 1 is a perspective view of a coloring web according to the present invention supported from the top of a door and being colored by a child playing with the toy;

FIG. 2 is an edge view of the door shown in FIG. 1;

FIG. 3 is a perspective view of a container for crayons; and

FIG. 4 is a perspective view of a weight which can be removably applied to the free lower end of the web.

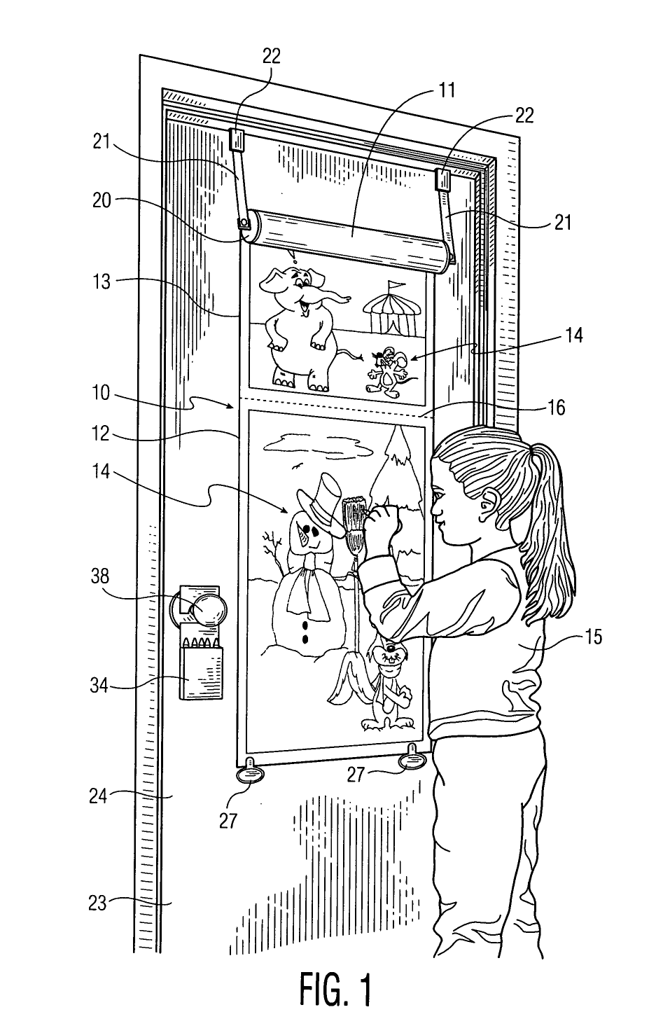

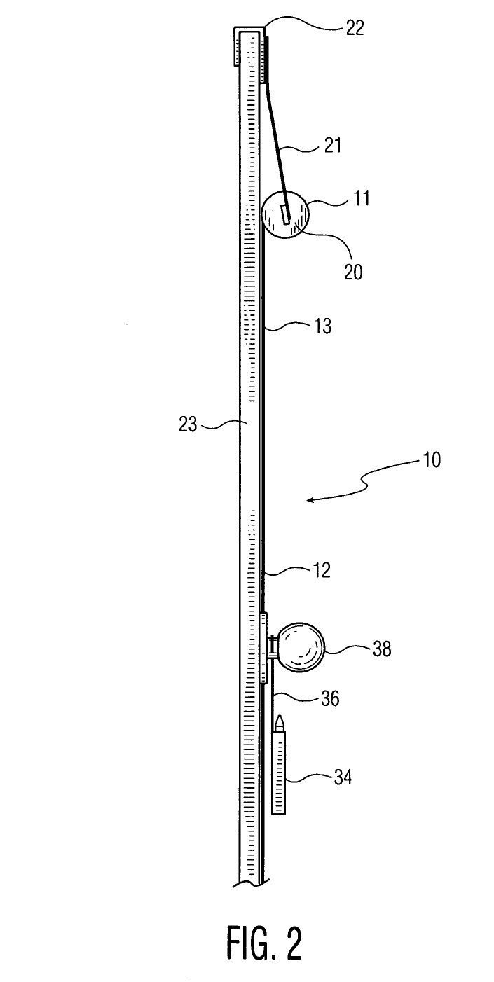

The coloring toy chosen to illustrate the present invention, and shown in FIGS. 1 and 2, includes an elongated flexible web 10 wound into a roll 11, the web including a series of sheets 12 and 13. Each sheet has printed on it a line drawing 14 defining discreet areas to be colored in by a child 15 playing with the toy. Web 10 is preferably made of paper, although any suitable flexible sheet material may be used.

While only two individual sheets 12 and 13 are illustrated, it is contemplated that roll 11 will contain more than two sheets, perhaps a dozen, each sheet bearing an image different from the images carried by the other sheets. Sheets 12 and 13, as well as the other sheets on roll 11, are joined in end-to-end relationship, and demarcated from each other by lines of severance 16. Line 16 could be a printed line to guide cutting by scissors to separate the sheets, or it could be a line of perforations to permit tearing the sheets apart. Alternatively, sheets 12 and 13, and the remaining sheets on roll 11, could be initially separate sheets joined together in end-to-end relationship by adhesive tape (not shown) which would then be removed or cut to separate the sheets.

Roll 11 may be conveniently wound about a spool 20 rotatable about its horizontal longitudinal axis. Each end of spool 20 has the lower end of a strap 21 secured to it, the upper end of each strap terminating in a squared-off hook 22. Each hook 22 is sized to fit over and accommodate the full thickness of a standard door 23. In this way, roll 11 can be mounted adjacent to the, preferably flat, surface 24 of door 23 by slipping hooks 22 over the top of the door.

Because web 10 is maintained in rolled condition until it is ready for use, a sheet pulled from the roll, e.g., sheet 12, will tend to be curled in the direction in which it was maintained while on roll 11. To help flatten the sheet, for ease of coloring it, one or more weights 27 (FIGS. 1 and 4) are provided. In the present example, each weight includes a body portion 28 having a clip 29 of somewhat flexible material projecting from one of its edges. Clip 29 includes a tongue 30 and an inverted U-shaped frame 31 surrounding the tongue. Clip 29 functions on a “paper clip” principle, i.e., it can temporarily grip the lower edge of sheet 12 by slipping that lower edge between tongue 30 and frame 31, as shown in FIG. 1.

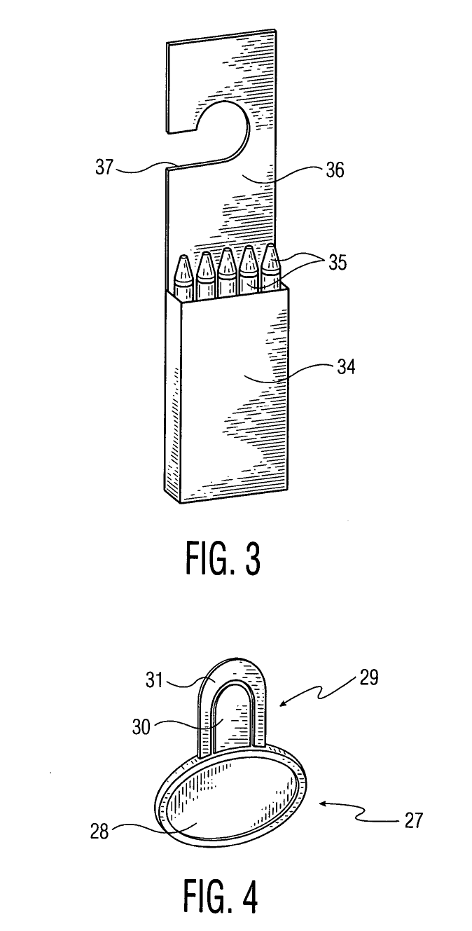

It is desirable to provide, along with rolled web 11, coloring implements, such as crayons, for use in coloring images 14. For this purpose, a container 34 (FIGS. 1 and 3) is provided accommodating a supply of crayons 35, or other coloring implements, as well as other decorative items such as stickers. Conveniently, container 34 is provided with an extension 36, which may be integral with one side of container 34. Extension 36 is formed with a notch or opening 37 adapted to accommodate the door knob 38 of door 23. As a result, crayons 35, and/or other decorative implements or items, are conveniently supported from door knob 38 directly adjacent to the sheet, say, sheet 12, on which the child is working.

In use, roll 11 is mounted against door surface 24 by being suspended from the top of door 23 using hooks 22. The endmost sheet 12 of he roll is pulled down along door surface 24 to any selected height most convenient for use by the particular child 15 who will be doing the coloring. Weights 27 are secured to the lower edge of sheet 12 to help hold it in a flat condition. Flat surface 24 of door 23 serves as the support surface for sheet 12 as the child colors in the various discrete areas of image 14. Once coloring has been completed, sheet 12 is removed from the remainder of the roll, such as by cutting or tearing along line 16. Sheet 13 can than be pulled downwardly from roll 11 to the desired height for use by the child.

The size of each sheet 12, 13 is limited only by the size of the door 23 which will serve to support the sheet during the coloring procedure. Thus, unlike previous coloring toys in which the sizes of the sheets for coloring were generally book size or somewhat larger, the sheets of the present invention to be colored can be the size of relatively large posters. For example, it is contemplated that each sheet can be in the range of 12 to 20 inches wide and 24 to 36 inches long. Sheets which are believed to work well are about 16 inches wide by 30 inches long.

The invention has been shown and described in preferred form only, and by way of example, and many variations may be made in the invention which will still be comprised within its spirit. It is understood, therefore, that the invention is not limited to any specific form or embodiment except insofar as such limitations are included in the appended claims.

1. A coloring toy comprising:
an elongated flexible web formed into a roll, the rolled web having a free end,
the web including a series of sheets each bearing an image to be colored, and
means for mounting the roll adjacent to a vertical support surface so that the roll is rotatable about its longitudinal axis, the longitudinal axis being generally horizontal,
whereby the free end of the rolled web can be grasped and pulled downwardly to unroll the endmost sheet of the web and bring it to a selected vertical location.

2. A coloring toy as defined in claim 1 wherein the vertical support surface is the side of a door, and the mounting means is adapted to engage the top of the door.

3. A coloring toy as defined in claim 2 wherein the mounting means includes at least one hook adapted to fit over the top of a door.

4. A coloring toy as defined in claim 1 including a spool upon which the web is rolled, and the mounting means engaging the ends of the spool.

5. A coloring toy as defined in claim 1 wherein the web includes means for demarcating adjacent sheets from each other.

6. A coloring toy as defined in claim 5 wherein the demarcating means is a printed line to guide severing of the adjacent sheets form each other.

7. A coloring toy as defined in claim 5 wherein the demarcating means is a line of perforations between adjacent sheets.

8. A coloring toy as defined in claim 1 including at least one weight, and means for removably securing the weight to the free end of the web to help maintain the lowermost sheet in a flat condition.

9. A coloring toy as defined in claim 8 wherein the securing means includes a clip for frictionally engaging the free end of the web.

10. A coloring toy as defined in claim 1 wherein each sheet is sized in the range of 12 to 20 inches wide and 24 to 36 inches long.

11. A coloring toy as defined in claim 1 wherein each sheet is about 16 inches wide and 30 inches long.

12. A coloring toy as defined in claim 1 wherein the vertical support surface is the side of a door, the door having a door knob, a container accommodating coloring implements for use in coloring the image, and means for hanging the container from the door knob.

13. A coloring toy as defined in claim 12 wherein the hanging means includes an extension projecting from the container, and an opening in the extension through which a door knob can pass.
